(19) United States
(12) Patent Application Publication
(10) Pub. No.: US 2006/0172140 A1
(43) Pub. Date: Aug. 3, 2006

(54) Silicone pressure sensitive adhesive composition and a pressure sensitive adhesive tape thereof

(75) Inventors: Yasuyoshi Kuroda, Annaka-shi (JP); Shunji Aoki, Annaka-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/345,327

(22) Filed: Feb. 2, 2006

(30) Foreign Application Priority Data
Feb. 3, 2005 (JP) 2005-027644

(51) Int. Cl. B32B 27/00; C08L 83/04; B32B 37/00

(52) U.S. Cl. 428/447; 524/588; 524/861; 524/862

(57) ABSTRACT

A silicone composition for use as a pressure sensitive adhesive, comprising
a mixture obtained by reacting (A) a polyorganosiloxane having at least two alkenyl groups per molecule with (B) a polyorganosiloxane having an R¹₃SiO_{0.5} unit and a SiO₂ unit, wherein R¹ may be the same with or different from each other and is a monovalent hydrocarbon group having 1 to 10 carbon atoms, (C) a polyorganosiloxane having an SiH group, (D) a retarder and (E) a platinum group metal catalyst. A pressure sensitive adhesive tape made from the composition can be peeled off from an object without leaving adhesive residue even after aged at a temperature of 250° C. or higher.

### CROSS REFERENCE

This application claims benefit of Japanese Patent application No. 2005-027644 filed on Feb. 3, 2005, the contents of which are hereby incorporated by reference.

### FIELD OF THE INVENTION

This invention relates to a silicone composition for use as a pressure sensitive adhesive and a pressure sensitive adhesive tape thereof. Specifically, the composition comprises a reaction product of two specific polyorganosiloxanes, and the adhesive tape having an adhesive layer made of the composition can be peeled off from an object to which the tape has been bonded without leaving substances originating from the composition on the object even after heat-aged at a temperature of from 250 to 300° C.

### DESCRIPTION OF THE PRIOR ART

Adhesive tapes and labels with silicone adhesive are excellent in heat resistance, cold resistance, weather resistance, electrical insulation, and chemical resistance and, therefore, used in severe environments where acrylic adhesives, rubber adhesives, urethane adhesives, or epoxy adhesives are damaged or degraded.

One of the severe environments is exposure to a temperature of 250° C. or higher, for example, in semiconductor production processes such as in a reflow process, and in a resin encapsulation process, wherein the adhesive tapes are used for masking or temporary fixing of semiconductor parts. Recently, heating at a higher temperature is practiced, which requires improvement in the heat resistance of the silicone adhesive.

For example, in a solder reflow process, a reflow temperature is higher than ever and a peak temperature sometimes reach 280° C., as lead-free solder became in practical use. Even at such a high temperature, an adhesive should not come off and, after the reflow process, should be peeled off without leaving any adhesive residue on an object to which the adhesive has been bonded.

When an adhesive tape made from conventional silicone adhesive is applied on metal object and exposed to a temperature of from 150 to 250° C., and then peeled off, the adhesive is left on the metal object or transferred from a base film of the adhesive tape to the metal. The left or transferred adhesive is referred to as adhesive residue in the present invention.

To prevent the adhesive residue from occurring, an antioxidant is incorporated in a silicone binder of a pressure sensitive adhesive tape as disclosed in Japanese Patent Application Laid-Open No. 2001-345415.

Japanese Patent Application Laid-Open No. 2003-96429 discloses a silicone adhesive composition, which is cured through an addition reaction, comprising a phenolic antioxidant. An adhesive tape made from the composition can be peeled off without leaving the adhesive residue on metal such as copper, even after heated to a temperature of from 150 to 250° C.

However, the antioxidants degrade at a temperature higher than 250° C. to lose its capability of preventing the adhesive residue from occurring. A metal such as copper, copper alloy or iron tends to be oxidized and bind to a silicone adhesive stronger to cause the adhesive residue.

The present inventors have found a pressure sensitive adhesive silicone composition which does not leave adhesive residues and filed a Japanese Patent Application No. 2004-112273.

The aforesaid silicone composition, however, sometimes discolors a metal surface to which it has been bonded. The discoloration is often found when the metal surface is flat, and particularly when the metal is stainless steel. This discoloration is hereinafter referred to as stain. The stain makes an appearance problem which should be solved.

### SUMMARY OF THE INVENTION

An object of the present invention is to provide a silicone pressure sensitive adhesive composition and a pressure sensitive adhesive tape thereof which, after it is bonded to a metal object and then exposed to a temperature of 250° C. or higher, can be peeled off from the metal object without leaving adhesive residues or stains on the metal object.

One aspect of the present invention is a silicone composition for use as a pressure sensitive adhesive, comprising

a mixture obtained by reacting (A) a polyorganosiloxane having at least two alkenyl groups per molecule with (B) a polyorganosiloxane having an R¹₃SiO_{0.5} unit and a SiO₂ unit, wherein R¹ may be the same with or different from each other and is a monovalent hydrocarbon group having 1 to 10 carbon atoms,

(C) a polyorganosiloxane having an SiH group,

(D) a retarder and

(E) a platinum group metal catalyst,

said composition leaving no residue originating from the composition on a surface of stainless steel when tested according to the following method:

(1) applying the composition on a substrate, followed by heating at a temperature of from 110 to 140° C. for 1 to 3 minutes to prepare a pressure sensitive adhesive tape,

(2) pressure bonding the applied composition of the pressure sensitive adhesive tape to the surface of stainless steel, followed by heating at a maximum temperature of from 250 to 300° C. for at least 10 minutes, and

(3) manually peeling off the pressure sensitive adhesive tape from stainless steel after cooled to room temperature and observing with the naked eye the surface of the stainless steel.

Another aspect of the present invention is a pressure sensitive adhesive tape comprising a substrate and a pressure sensitive adhesive layer provided on the substrate, wherein the pressure sensitive adhesive layer comprises the aforesaid silicone composition.

The pressure sensitive adhesive tape having an adhesive layer made of the silicone composition of the present invention does not leave adhesive residues or stains even after aged at a temperature of 250° C. or higher. The pressure sensitive adhesive tape is useful as a masking tape for metal, particularly circuits on printed circuit boards. It is also useful as an easy-to-peel tape, or a wide tape or sheet.

### DESCRIPTION OF THE PREFERRED EMBODIMENTS

The present silicone pressure sensitive adhesive composition comprises a mixture obtained by reacting (A) a polyorganosiloxane having at least two alkenyl groups per molecule with (B) a polyorganosiloxane having an R¹₃SiO_{0.5} unit and an SiO₂ unit, wherein R¹ may be the same with or different from each other and is a monovalent hydrocarbon group having 1 to 10 carbon atoms,

(C) a polyorganosiloxane having a SiH group,

(D) a retarder and

(E) a platinum group metal catalyst.

Each component is explained below.

The polyorganosiloxane (A) has at least two alkenyl groups per molecule, preferably has an alkenyl group content of from 0.0015 to 0.06 mole/100 g, more preferably of from 0.002 to 0.04 mole/100 g. A polyorganosiloxane having less than two alkenyl groups per molecule cannot form a polysiloxane network structure.

Preferred polyorganosiloxane (A) are represented by the following formulas or a mixture thereof:
R¹₍₃₋ₐ₎XₐSiO—(R¹XSiO)ₙ—(R¹₂SiO)ₙ—SiR¹₍₃₋ₐ₎Xₐ
R¹₂(HO)SiO—(R¹XSiO)ₙ₊₂(R¹₂SiO)ₙ—SiR¹₂(OH)

wherein R¹ may be the same with or different from each other and is a monovalent hydrocarbon group having no aliphatic unsaturated group, X is an organic group having an alkenyl group, a is an integer of from 0 to 3, preferably 1, m is a number of 0 or larger, n is a number of 100 or larger, provided that a and m are not 0 simultaneously, and m+n is such a number that the organosiloxane has a viscosity of 500 mPa·s or larger at 25° C.

Preferably, R¹ is a hydrocarbon group having 1 to 10 carbon atoms of which examples include alkyl groups such as methyl, ethyl, propyl, and butyl groups; alicyclic groups such as cyclohexyl group; and aryl groups such as phenyl and tolyl groups, among which methyl and phenyl groups are particularly preferred.

Preferably, X having an alkenyl group has 2 to 10 carbon atoms. Examples of X include vinyl, allyl, hexenyl, octenyl, acryloylpropyl, acryloylmethyl, methacryloylpropyl, cyclohexenylethyl, and vinyloxypropyl groups, among which a vinyl group is particularly preferred from the industrial viewpoint.

The polyorganosiloxane (A) may be oily or gummy. When the polyorganosiloxane (A) is oily, it preferably has a viscosity at 25° C. of 1000 mPa·s or higher, particularly 16,000 mPa·s or higher. If the viscosity is below the aforesaid lower limit, a curing property of a composition may not be good or cohesive strength, i.e., holding power, may be undesirably smaller. When the polyorganosiloxane (A) is gummy, it preferably has a viscosity in a 30 wt % solution in toluene of 100,000 mPa·s or lower. If the viscosity exceeds the aforesaid upper limit, a composition may be so viscous that the composition is difficult to be agitated in a preparation process. The polyorganosiloxane (A) may be a mixture of two or more kinds of the polyorganosiloxane.

The polyorganosiloxane (B) has R¹₃SiO_{0.5} units and SiO₂ units with a molar ratio of the R¹₃SiO_{0.5} units to the SiO₂ units of from 0.6 to 1.7, wherein R¹ is as defined above. A polyorganosiloxane having the molar ratio outside the aforesaid range may give a pressure sensitive adhesive layer having too small adhesion strength, tackiness or holding power.

The polyorganosiloxane (B) may have an OH-group in an amount of 4.0 wt % or less based on a total weight of the polyorganosiloxane (B). A polyorganosiloxane having an OH-group more than the aforesaid amount may give a composition having insufficient curing property. The polyorganosiloxane (B) may also have an R¹SiO_{1.5} unit and/or an R¹₂SiO unit in such an amount that the properties of the present composition are not spoiled. The polyorganosiloxane (B) may be a mixture or a condensation product of two or more kinds of the polyorganosiloxane.

The present pressure sensitive adhesive composition comprises a mixture obtained by reacting the polyorganosiloxane (A) with the polyorganosiloxane (B) under predetermined conditions. The reaction is performed by heating a solution of the polyorganosiloxane (A) and (B) in an organic solvent such as toluene, xylene, hexane, heptane, isooctane, octane and ethylbenzene to a temperature of from 80 to 150° C. for 2 to 24 hours in the presence of a basic catalyst. In the reaction, reaction products between the polyorganosiloxane (B) themselves and between the polyorganosiloxane (A) with (B) are produced. In the reaction, relatively low molecular weight polyorganosiloxanes, which are considered to cause the adhesive residue or stain, are converted to higher molecular weight polyorganosiloxanes, and thereby prevented from transferring from the composition to a metal object at a high temperature.

Examples of the organic solvent include aromatic hydrocarbons such as toluene and xylene; aliphatic hydrocarbons such as hexane, heptane, octane, isooctane, decane, cyclohexane, methylcyclohexane, and isoparaffin; other hydrocarbon solvents such as industrial grade gasoline, petroleum benzene, and naphtha solvent; ketones such as acetone, methylethylketone, 2-pentanone, 3-pentanone, 2-hexanone, 2-heptanone, 4-heptanone, methylisobutylketone, diisobutylketone, acetonylacetone, and cyclohexanone; esters such as ethyl acetate, propyl acetate, isopropyl acetate, butyl acetate, and isobutyl acetate; ethers such as dibutyl ether, 1,2-dimethoxyethane, and 1,4-dioxane; multi functional solvents such as 2-methoxyethylacetate, 2-ethoxyethylacetate, propyleneglycol monomethylether acetate, and 2-butoxyethylacetate; siloxanes such as hexamethyldisiloxane, octamethyltrisiloxane, octamethylcyclotetrasiloxane, decamethylcyclopentasiloxane, and tris(trimethylsiloxane)-methylsilane; and a mixture thereof, among which the aromatic hydrocarbons, the aliphatic hydrocarbons and a mixture thereof are industrially preferred.

Any basic catalyst capable of promoting the condensation of the polyorganosiloxane (A) with (B) may be used as far as it does not hinder addition reaction between alkenyl groups and SiH groups.

Examples of the basic catalyst include metal oxides such as lithium hydroxide, sodium hydroxide, potassium hydroxide, and calcium hydroxide; carbonate salts such as sodium carbonate, potassium carbonate, and potassium hydrogen carbonate; metal alkoxides such as sodium methoxide, and potassium butoxide; organic metal compounds such as butyl lithium; and nitrogen compounds such as ammonia gas, ammonia water, methylamine, trimethylamine, triethylamine; among which ammonia gas and ammonia water are preferred.

The reaction temperature may range from 80 to 150° C., typically under reflux of the aforesaid solvent. The reaction time may typically range from 1 to 24 hours, more typically from 2 to 10 hours.

After the reaction completes, the basic catalyst may be neutralized by a neutralizing agent, for example, acidic gas such as hydrogen chloride, or carbon dioxide gas; organic acid such as acetic acid, octyl acid, or citric acid; and mineral acid such as hydrochloric acid, sulfuric acid, or phosphoric acid.

In the present composition, a weight ratio of (A)/(B) ranges from 20/95 to 80/5, preferably from 30/70 to 70/30. If the weight ratio is outside the aforesaid range, a satisfactory cohesive strength of the composition may not be attained.

The organosiloxane (C) having a SiH group reacts with an alkenyl group of the polyorganosiloxane (A) or its reaction product to form a crosslinking. The organosiloxane (C) preferably has at least three SiH groups per molecule and may be linear, branched or cyclic.

The organosiloxane (C) has a siloxane repeating unit having no SiH group in addition to those having SiH groups. Preferably, a ratio of the latter repeating unit to the former repeating unit ranges from 5/5 to 9/1, more preferably from 6/4 to 8/2.

Preferred polyorganosiloxane (C) having both siloxane units with SiH groups and those without SiH groups is at least one selected from the polyorganosiloxanes represented by the following formulas:

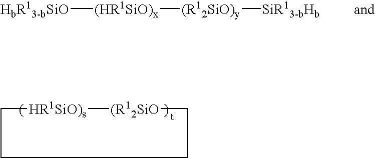

wherein R¹ is the hydrocarbon group as defined above; b is 0 or 1; x is an integer of 1 or larger, provided that x is 3 or larger when b is zero, and y is an integer of 1 or larger, s is an integer of 3 or larger, t is an integer of 1 or larger, preferably a sum of s and t ranging from 3 to 8. The above polyorganosiloxane, with y or t being an integer of 1 or larger, has a siloxane unit with no SiH group besides siloxane units having SiH groups. These units may be bonded in blocks or randomly. A polyorganosiloxane consisting solely of the siloxane units having SiH groups may cause a trace of adhesive residue, which may be a very slight adhesive residue.

Preferably, a viscosity at 25° C. of the polyorganosiloxane (C) ranges from 1 to 5,000 mPa·s, more preferably from 5 to 500 mPa·s.

The polyorganosiloxane (C) may be used in such an amount that a molar ratio of the SiH group in component (C) to the alkenyl group of component (A) ranges from 0.1 to 20, preferably from 1 to 15. A composition with the ratio below the aforesaid lower limit may have too low crosslinking density to have appropriate adhesion strength and enough holding power to leave no adhesive residues. A composition with the ratio above the aforesaid upper limit may not have satisfactory adhesion strength or tackiness, and its shelf life may be short.

The retarder (D) is used to prevent the present composition from becoming thicker or from gelling before heat curing. Examples of component (F) include 3-methyl-1-butyn-3-ol, 3-methyl-1-pentyn-3-ol, 3,5-dimethyl-1-hexyn-3-ol, 1-etynylcyclohexanol, 3-methyl-3-trimethylsiloxy-1-butyn, 3-methyl-3-trimethylsiloxy-1-pentyn, 3,5-dimethyl-3-trimethylsiloxy-1-hexyn, 1-ethynyl-1-trimethysiloxy cyclohexane, bis(2,2-dimethyl-3-butynoxy)dimethyl silane, 1,3,5,7-tetramethyl-1,3,5,7-tetravinyl cyclotetrasiloxane, and 1,1,3,3-tetramethyl-1,3-divinyl disiloxane.

The retarder (D) is incorporated in the present composition in an amount, based on a total 100 parts by weight of components (A) and (B) before reacted, of from 0 to 8.0 parts by weight, more preferably 0.05 to 2.0 parts by weight. If the amount exceeds the aforesaid upper limit, the composition may not be cured properly.

Examples of the platinum group metal catalyst (E) include chloroplatinic acid, alcohol solutions of chloroplatinic acid, reaction products of chloroplatinic acid with alcohols, reaction products of chloroplatinic acid with olefin compounds, and reaction products of chloroplatinic acid with siloxane having a vinyl group, among which the reaction products of chloroplatinic acid with siloxane having a vinyl group is preferred such as CAT-PL-50T, ex Shin-Etsu Chemical Co. Ltd.

Component (E) is incorporated in the composition in an amount, calculated as platinum, ranges from 1 to 5,000 ppm, preferably from 5 to 2,000 ppm based on a total 100 parts by weight of components (A) and (B) before reacted. If the amount is below the aforesaid lower limit, insufficient curing, lower crosslinking density and smaller holding power may be caused. The catalyst in an amount exceeding the aforesaid upper limit may shorten a serviceable time of a composition and be economically disadvantageous due to a high price of the catalyst.

The present pressure sensitive adhesive composition comprising the reaction products of (A) with (B), (C), (D) and (E) is characterized in that no adhesive residue originating from the composition is observed in the following test, hereinafter referred to as adhesive residue test:

(1) applying the silicone composition on a substrate such as a base tape, preferably in such a thickness that a thickness after cured ranges from 23 to 32 μm, followed by heating at a temperature of from 110 to 140° C. for 1 to 3 minutes to prepare a pressure sensitive adhesive tape,

(2) pressure bonding the adhesive side of the pressure sensitive adhesive tape to a surface of stainless steel followed by heating at a maximum temperature of from 250 to 300° C. for at least 10 minutes, and

(3) manually peeling off the pressure sensitive tape from stainless steel after cooled to room temperature followed by and observing with the naked eye the surface of stainless.

The test method simulates actual semiconductor manufacturing processes, particularly a reflow process. In the step (1), any commercially available base tape can be used, for example, polymer tapes such as polyimide, polytetrafluoroethylene, polyphenylene sulfide, polyamide, and polycarbonate tapes; metal foil tapes such as aluminum and copper foil tapes; paper tapes such as Japanese paper, synthetic paper, and polyethylene-laminated tapes; cloth tape and glass fiber tape. Results of this test do not depend on the substrate.

In the step (2), by selecting the maximum temperature and its duration time according to a user's process, the adhesive residue test provides a criterion whether a composition meets the user's need or not. Instead of the stainless steel, copper, aluminum, gold plated copper, or copper alloy may be used. The observation in the step (3) can be done with instrumental analyses, but visual observation was found to be sufficient to prevent problems in post processes caused by adhesive residues.

A pressure sensitive adhesive tape prepared by applying the present composition on a 25 mm wide polyimide base tape in the step (1) preferably has a 180-degree peel strength of from 0.05 to 4 N/25 mm, more preferably from 0.05 to 3 N/25 mm, as measured at a pulling rate of 300 mm/min at 25° C., after allowed to stand at room temperature for 18 to 22 hours. The peel strength can be an index of pressure sensitive adhesive strength at room temperature. As shown in the after described Examples, a pressure sensitive tape having a peel strength below the aforesaid lower limit does not adhere well to an object. A pressure sensitive tape having a peel strength above the aforesaid upper limit tends to show adhesive residue. It should be noted that 180-degree peel strength depends on elasticity of the base tape, so that it is preferred to select an appropriate base tape according to an intended use of a pressure sensitive tape in question.

The present silicone composition does not show the stain, either. It is not clarified how the stain is formed, but transfer of low molecular weight substances is considered to be one of the causes of the stain. It was found that the stain tends to occur on a flat surface of a metal object, particularly stainless steel object. It was also found that the stains tend to occur where a pressure sensitive adhesive layer is not adhered to an object due to entrapped air between the layer and the object. Based on these findings, the stain test in the present invention uses a mirror-finished stainless steel plate and a pressure sensitive tape is bonded to the plate in such a way that a small air bubble is entrapped between the tape and the plate. Details of the test will be described later.

The present composition may contain (F) a hindered amine compound to improve heat resistance, and thereby preventing adhesive residue. Preferably, the hindered amine (F) is represented by the following formula:

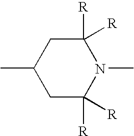

wherein R may be the same with or different from each other and is a monovalent hydrocarbon group having 1 to 6 carbon atoms such as an alkyl group, e.g., methyl, ethyl, propyl, and butyl groups; an alicyclic group, e.g., cyclohexyl group; and an aryl group, e.g., phenyl group, among which a methyl group is particularly preferred.

Examples of the hindered amine having the aforesaid strucure are as shown below.

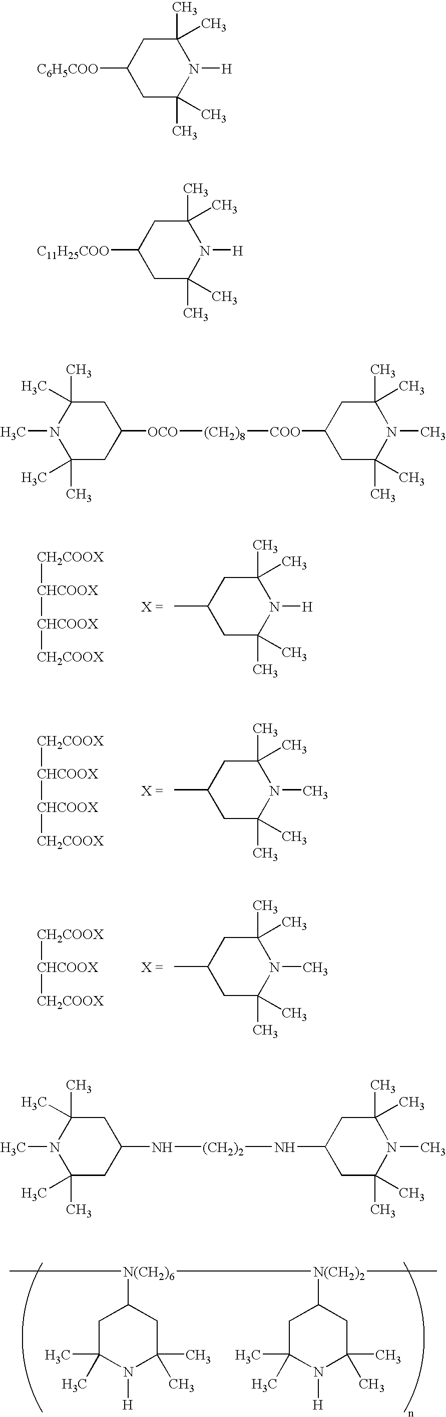

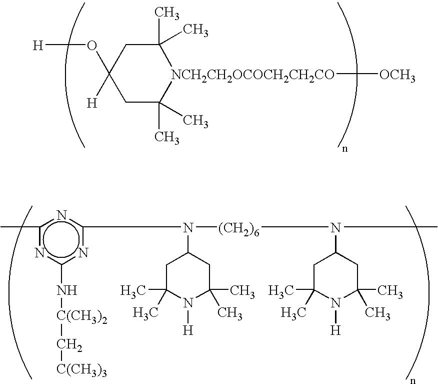

Component (F) is incorporated in the composition in an amount, based on a total 100 parts by weight of components (A) and (B), of from 0.01 to 1 part by weight, preferably from 0.05 to 0.5 part by weight. If the amount is below the aforesaid lower limit, heat resistance may not be improved. If the amount exceeds the aforesaid upper limit, holding power may be lowered. Component (F) may be a mixture of two or more kinds of the hindered amine.

In addition to or instead of the aforesaid hindered amine (F), (G) a phenolic antioxidant may be added. Preferred phenolic antioxidant (G) has the following structure.

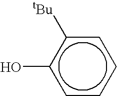

Examples of the phenolic antioxidant having the aforesaid structure are as shown below.

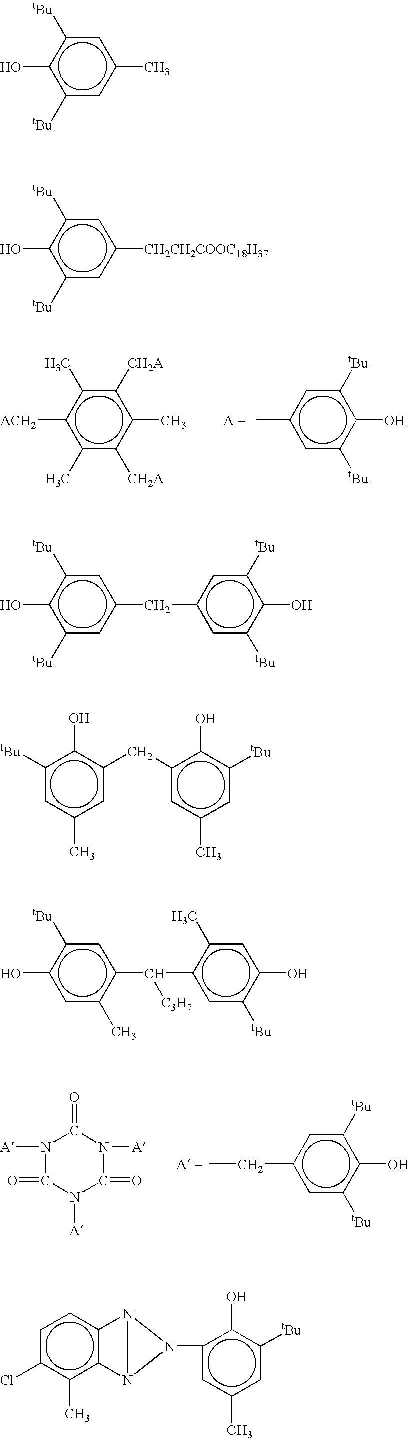

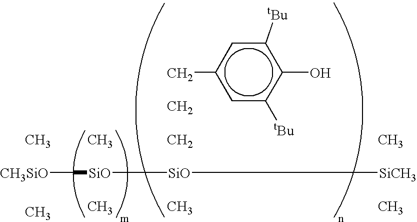

wherein m is an integer of at least 0, and n is an integer of at least 1.

Component (G) may be incorporated in the composition in an amount, based on a total 100 parts by weight of components (A) and (B), of from 0.1 to 10 parts by weight, preferably from 0.5 to 5 parts by weight. Component (G) in an amount below the aforesaid lower limit may not sufficiently prevent adhesive residues after the composition is exposed to a high temperature. Component (G) in an amount exceeding the aforesaid upper limit may impair adhesive property.

In addition to the aforesaid components, the present silicone adhesive composition may comprise optional components. Examples of such components include non-reactive polyorganosiloxanes such as polydimethylsiloxane and polydimethyldiphenylsiloxane; antioxidants such as phenol type, quinone type, amine type, phosphorus type, phosphite type, sulfur type, and thioether type antioxidants; photostabilizers such as triazole type and benzophenone type photostabilizers; flame retardants such as phosphate ester type, halogen type, phosphorus type, and antimony type flame retardants; antistatic agents such as cationic surfactants, anionic surfactants, and nonionic surfactants; solvents for lowering the viscosity in application, for example, aromatic solvents such as toluene and xylene, aliphatic solvents such as hexane, octane and isoparaffins, ketones such as methyl ethyl ketone and methyl isobutyl ketone, esters such as ethyl acetate and isobutyl acetate, and ethers such as diisopropyl ether and 1,4-dioxane; and mixtures thereof; and dyes and pigments.

The silicone adhesive composition as described above may be applied on various kinds of substrates and cured in predetermined conditions to form an adhesive layer. Examples of the substrates include plastic films such as films of polyester, polytetrafluoroethylene, polyimide, polyphenylene sulfide, polyamide, polycarbonate, polystyrene, polypropylene, polyethylene, and polyvinyl chloride; metal foils such as aluminum foil and copper foil; papers such as Japanese paper, synthetic paper and polyethylene-laminated paper; fabrics; glass fibers; and laminated composites of a plurality of the aforesaid materials.

To improve adhesion between the substrate and the adhesive layer, the substrate may be treated by primer coating, corona treatment, etching and plasma treatment.

To apply the composition, any known means or method for application may be used, for example, a comma coater, a lip coater, a roll coater, a die coater, a knife coater, a blade coater, a rod coater, a kiss-roll coater, and a gravure coater; screen printing, dipping and casting methods. The amount of the composition to be applied on a substrate is selected according to use of the composition. Typically, the amount is such that a cured adhesive layer has a thickness of from 2 to 200 μm, particularly from 5 to 50 μm for use as a masking tape.

Curing conditions of the applied composition are selected according to an applied amount, but typically at a temperature of from 80 to 130° C. for 30 seconds to 3 minutes.

The adhesive tape may be prepared by applying the composition directly on the substrate as described above, or by applying the composition on a release film or a release paper coated with a releasing agent followed by curing the composition and then transferring the cured composition on the releasing film or paper on the aforesaid substrate.

The adhesive tape may be bonded to any object for example, metals such as stainless steel, copper, iron; plated or antirust-treated metals as described above; glass; porcelain and pottery; ceramics; resins such as polytetrafluoroethylene, polyimide, epoxy resins and Novolak resin; and composites thereof.

### EXAMPLES

The present invention will be explained with reference to the following non-limiting Examples and Comparative Examples, wherein the term “parts” means parts by weight, “Me” a methyl group, and “Vi” a vinyl group.

Each compositions prepared was subjected to the following tests.

Adhesive Residue

An adhesive tape was prepared by applying a solution of a silicone adhesive composition on a polyimide film of 25 μm in thickness and 25 mm in width with an applicator in such a thickness that a thickness after cured was 30 μm, followed by curing at 130° C. for 1 minute. The tape was attached on a polished stainless steel plate and pressed onto the metal plate by rolling a rubber-lined roller of 2 kg in weight back and forth on the tape. Then, the metal plate with the tape thereon was left in a thermostatic oven at 280° C. After a predetermined period of time shown in Table 1, the metal plate with the tape thereon was taken out and cooled to room temperature. Then, the tape was peeled from the metal plate and visually observed whether any adhesive residues were left on the metal surface, due to the breakage of the pressure sensitive adhesive layer. The tape was rated according to the following criteria.

A: No adhesive residue observed

B: Adhesive residue observed on a part of the surface

C: Adhesive residue left on the entire surface

Stain

An adhesive tape was prepared in the same manner as in the adhesive residue test. Two mirror-finished stainless steel plates 1 and 2 each having a width of 25 mm and a thickness of 1 mm were arranged in a cruciform structure, so that the plate 2 placed on the plate 1 formed a step of 1 mm in height. The adhesive tape was attached on the plates 1 and 2 in such a manner that it stepped over the step with air entrapped between the tape and the plate 1. The attached tape was pressed onto the plate 1 by rolling a rubber-lined roller of 2 kg in weight back and forth on the tape. Then, the plates 1 and 2 with the tape thereon was left in a thermostatic at 280° C. After a predetermined period of time, the metal plates 1 and 2 with the tape thereon was taken out and cooled to room temperature. Then, the tape was peeled off from the metal plates and visually observed whether any discoloration took place around the step where the air was entrapped. The tape was rated according to the following criteria.

A: No discoloration observed

B: Discoloration observed

C: Unobservable due to adhesive residues

Adhesion Strength

A pressure sensitive adhesive tape was prepared and attached to a stainless steel plate in the same manner as in the adhesive residue test. After leaving the steel plate with the tape thereon at 25° C. for about 20 hours, a 180-degree peel force in N/25 mm required to peel the tape off from the steel plate was measured using a tensile tester at a pulling rate of 300 mm/min.

### Example 1

To a mixture of 40 parts of a polydimethylsiloxane which was end-capped with SiMe₂Vi groups and had an alkenyl content of 0.007 mole/100 g and a viscosity in a 30% solution in toluene of 27,000 mPa·s, 100 parts of a 60% solution in toluene of polysiloxane comprising Me₃SiO_{0.5} units and SiO₂ units with a ratio of Me₃SiO_{0.5} units/SiO₂ units being 0.80, and 23.3 parts of toluene, 0.5 part of a 28% aqueous solution of ammonia was added and stirred for 6 hours at room temperature. Then, ammonia and water were removed by heating under reflux for 4 hours. After leaving the mixture to cool, toluene was added to the mixture to compensate for evaporated toluene. To 100 parts of the mixture thus obtained, 1.25 parts of a polyorganosiloxane having three SiH groups per molecule represented by the following formula:
Me₃SiO—[MeHSiO]₄₅—[Me₂SiO]₁₇—SiMe₃

and 0.1 part of ethynylhexanol were added and mixed. To 100 parts of the mixture thus obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Referential Example 1

A mixture was prepared by mixing 40 parts of a polydimethylsiloxane which was end-capped with SiMe₂Vi groups and had an alkenyl content of 0.007 mole/100 g and a viscosity in a 30% solution in toluene of 27,000 mPa·s, 100 parts of a 60% solution in toluene of polysiloxane comprising Me₃SiO_{0.5} units and SiO₂ units with a ratio of Me₃SiO_{0.5} units/SiO₂ units being 0.80, and 23.3 parts of toluene. To 100 parts of the mixture, 1.25 parts of the polyorganosiloxane represented by the following formula:
Me₃SiO—[MeHSiO]₄₅—[Me₂SiO]₁₇—SiMe₃

and 0.1 part of ethynylhexanol were added and mixed. To 100 parts of the mixture thus obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Example 2

To a mixture of 40 parts of a polydimethylsiloxane which was end-capped with SiMe₂Vi groups and had an alkenyl content of 0.02 mole/100 g and a viscosity in a 30% solution in toluene of 21,500 mPa·s, 100 parts of a 60% solution in toluene of polysiloxane comprising Me₃SiO_{0.5} units and SiO₂ units with a ratio of Me₃SiO_{0.5} units/SiO₂ units being 0.80, and 23.3 parts of toluene, 0.5 part of a 28% aqueous solution of ammonia was added and stirred for 6 hours at room temperature. Then, ammonia and water were removed by heating under reflux for 4 hours. After leaving the mixture to cool, toluene was added to compensate for evaporated toluene. To 100 parts of the mixture thus obtained, 3.67 parts of the polyorganosiloxane used in Example 1 and 0.1 part of ethynylhexanol were added and mixed. To 100 parts of the mixture thus obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Referential Example 2

A mixture was prepared by mixing 40 parts of a polydimethylsiloxane which was end-capped with SiMe₂Vi groups and had an alkenyl content of 0.02 mole/100 g and a viscosity in a 30% solution in toluene of 21,500 mPa·s, 100 parts of a 60% solution in toluene of polysiloxane comprising Me₃SiO_{0.5} units and SiO₂ units with a ratio of Me₃SiO_{0.5} units/SiO₂ units being 0.80, and 23.3 parts of toluene. To 100 parts of the mixture, 3.67 parts of the polyorganosiloxane used in Example 1 and 0.1 part of ethynylhexanol were added and mixed. To 100 parts of the mixture obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Example 3

To a mixture of 40 parts of a polydimethylsiloxane which was end-capped with SiMe₂Vi groups and had an alkenyl content of 0.04 mole/100 g and a viscosity in a 30% solution in toluene of 24,000 mPa·s, 100 parts of a 60% solution in toluene of polysiloxane comprising Me₃SiO_{0.5} units and SiO₂ units with a ratio of Me₃SiO_{0.5} units/SiO₂ units being 0.80, and 23.3 parts of toluene, 0.5 part of a 28% aqueous solution of ammonia was added and stirred for 6 hours at room temperature. Then, ammonia and water were removed by heating under reflux for 4 hours. After leaving the mixture to cool, toluene was added to compensate for evaporated toluene. To 100 parts of the mixture, 7.34 parts of the polyorganosiloxane used in Example 1 and 0.1 part of ethynylhexanol were added and mixed. To 100 parts of the mixture obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Referential Example 3

A mixture was prepared by mixing 40 parts of a polydimethylsiloxane which was end-capped with SiMe₂Vi groups and had an alkenyl content of 0.04 mole/100 g and a viscosity in a 30% solution in toluene of 24,000 mPa·s, 100 parts of a 60% solution in toluene of polysiloxane comprising Me₃SiO_{0.5} units and SiO₂ units with a ratio of Me₃SiO_{0.5} units/SiO₂ units being 0.80, and 23.3 parts of toluene. To 100 parts of the mixture, 7.34 parts of the polyorganosiloxane used in Example 1 and 0.1 part of ethynylhexanol were added and mixed. To 100 parts of the mixture obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Example 4

To a mixture of 60 parts of a polydimethylsiloxane which was end-capped with SiMe₂Vi groups and had an alkenyl content of 0.007 mole/100 g and a viscosity in a 30% solution in toluene of 27,000 mPa·s, 67 parts of a 60% solution in toluene of polysiloxane comprising Me₃SiO_{0.5} units and SiO₂ units with a ratio of Me₃SiO₀₅ units/SiO₂ units being 0.80, and 40 parts of toluene, 0.5 part of a 28% aqueous solution of ammonia was added and stirred for 6 hours at room temperature. Then, ammonia and water were removed by heating under reflux for 4 hours. After leaving the mixture to cool, toluene was added to compensate for evaporated toluene. To 100 parts of the mixture, 1.87 parts of the polyorganosiloxane used in Example 1 and 0.1 part of ethynylhexanol were added and mixed. To 100 parts of the mixture obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Referential Example 4

A mixture was prepared by mixing 60 parts of a polydimethylsiloxane which was end-capped with SiMe₂Vi groups and had an alkenyl content of 0.007 mole/100 g and a viscosity in a 30% solution in toluene of 27,000 mPa·s, 67 parts of a 60% solution in toluene of polysiloxane comprising Me₃SiO_{0.5} units and SiO₂ units with a ratio of Me₃SiO_{0.5} units/SiO₂ units being 0.80, and 40 parts of toluene. To 100 parts of the mixture, 1.87 parts of the polyorganosiloxane used in Example 1 and 0.1 part of ethynylhexanol were added and mixed. To 100 parts of the mixture obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Example 5

To 100 parts of the pressure sensitive adhesive silicone composition prepared in Example 1, 0.2 part of a hindered amine compound of the following formula (I), Adekastab LA57, ex Asahi Denka Co, Ltd., was added and mixed.

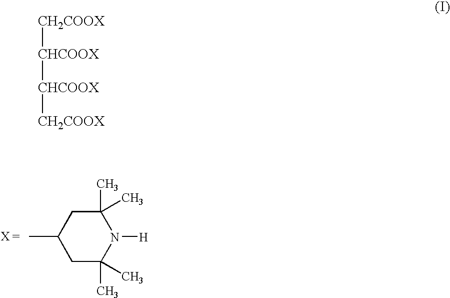

To 100 parts of the mixture obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Referential Example 5

To 100 parts of the pressure sensitive adhesive silicone composition prepared in Referential Example 1, 0.2 part of the aforesaid hindered amine compound (I), Adekastab LA57, ex Asahi Denka Co, Ltd., was added and mixed. To 100 parts of the mixture obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Example 6

To 100 parts of the pressure sensitive adhesive silicone composition prepared in Example 1, 0.5 part of a phenolic antioxidant of the following formula (II), IRGANOX 1330, ex Chiba Specialty Chemicals Co. Ltd. was added.

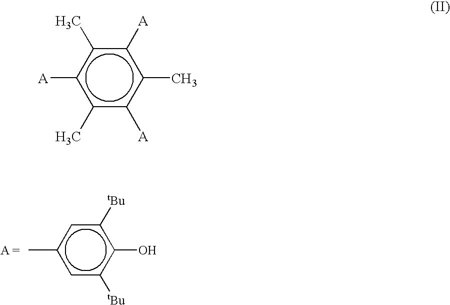

To 100 parts of the mixture obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Referential Example 6

To 100 parts of the pressure sensitive adhesive silicone composition prepared in Referential Example 1, 0.5 part of the phenolic antioxidant (II) used in Example 6 was added. To 100 parts of the mixture obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Comparative Example 1

To a mixture of 40 parts of a polydimethylsiloxane which was end-capped with SiMe₂Vi groups and had an alkenyl content of 0.0014 mole/100 g and a viscosity in a 30% solution in toluene of 20,000 mPa·s, 100 parts of a 60% solution in toluene of polysiloxane comprising Me₃SiO_{0.5} units and SiO₂ units with a ratio of Me₃SiO_{0.5} units/SiO₂ units being 0.80, and 23.3 parts of toluene, 0.5 part of a 28% aqueous solution of ammonia was added and stirred for 6 hours at room temperature. Then, ammonia and water were removed by heating under reflux for 4 hours. After leaving the mixture to cool, toluene was added to compensate for evaporated toluene. To 100 parts of the mixture, 0.28 part of the polyorganosiloxane used in Example 1 and 0.1 part of ethynylhexanol were added and mixed. To 100 parts of the mixture obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Comparative Example 2

A mixture was prepared by mixing 40 parts of a polydimethylsiloxane which was end-capped with SiMe₂Vi groups and had an alkenyl content of 0.0014 mole/100 g and a viscosity in a 30% solution in toluene of 20,000 mPa·s, 100 parts of a 60% solution in toluene of polysiloxane comprising Me₃SiO_{0.5} units and SiO₂ units with a ratio of Me₃SiO_{0.5} units/SiO₂ units being 0.80, and 23.3 parts of toluene. To 100 parts of the mixture, 0.28 part of the polyorganosiloxane used in Example 1 and 0.1 part of ethynylhexanol were added and mixed. To 100 parts of the mixture obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Comparative Example 3

To a mixture of 40 parts of a polydimethylsiloxane which was end-capped with SiMe₂Vi groups and had an alkenyl content of 0.007 mole/100 g and a viscosity in a 30% solution in toluene of 24,000 mPa·s, 100 parts of a 60% solution in toluene of polysiloxane comprising Me₃SiO_{0.5} units and SiO₂ units with a ratio of Me₃SiO_{0.5} units/SiO₂ units being 0.80, 23.3 parts of toluene, 0.5 part of a 28% aqueous solution of ammonia was added and stirred for 6 hours at room temperature. Then, ammonia and water were removed by heating under reflux for 4 hours. After leaving the mixture to cool, toluene was added to compensate for evaporated toluene. To 100 parts of the mixture thus obtained, 0.87 part of a polyorganosiloxane represented by the following formula:
Me₃SiO—[MeHSiO]₄₀—SiMe₃

and 0.1 part of ethynylhexanol were added and mixed. To 100 parts of the mixture obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Comparative Example 4

A mixture was prepared by mixing 40 parts of a polydimethylsiloxane which was end-capped with SiMe₂Vi groups and had an alkenyl content of 0.007 mole/100 g and a viscosity in a 30% solution in toluene of 24,000 mPa·s, 100 parts of a 60% solution in toluene of polysiloxane comprising Me₃SiO_{0.5} units and SiO₂ units with a ratio of Me₃SiO_{0.5} units/SiO₂ units being 0.80, and 23.3 parts of toluene. To 100 parts of the mixture, 0.87 part of a polyorganosiloxane represented by the following formula:
Me₃SiO—[MeHSiO]₄₀—SiMe₃

and 0.1 part of ethynylhexanol were added and mixed. To 100 parts of the mixture obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Comparative Example 5

To a mixture of 60 parts of a polydimethylsiloxane which was end-capped with SiMe₂Vi groups and had an alkenyl content of 0.007 mole/100 g and a viscosity in a 30% solution in toluene of 27,000 mPa·s, 67 parts of a 60% solution in toluene of polysiloxane comprising Me₃SiO_{0.5} units and SiO₂ units with a ratio of Me₃SiO_{0.5} units/SiO₂ units being 0.80, and 40 parts of toluene, 0.5 part of a 28% aqueous solution of ammonia was added and stirred for 6 hours at room temperature. Then, ammonia and water were removed by heating under reflux for 4 hours. After leaving the mixture to cool, toluene was added to compensate for evaporated toluene. To 100 parts of the mixture obtained, 1.31 parts of the polyorganosiloxane used in Comparative Example 2, and 0.1 part of ethynyhexanol were addend and stirred. To 100 parts of the mixture obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

### Comparative Example 6

A mixture was prepared by mixing 60 parts of a polydimethylsiloxane which was end-capped with SiMe₂Vi groups and had an alkenyl content of 0.007 mole/100 g and a viscosity in a 30% solution in toluene of 27,000 mPa·s, 67 parts of a 60% solution in toluene of polysiloxane comprising Me₃SiO_{0.5} units and SiO₂ units with a ratio of Me₃SiO_{0.5} units/SiO₂ units being 0.80, and 40 parts of toluene. To 100 parts of the mixture, 1.31 parts of the polyorganosiloxane used in Comparative Example 2 and 0.1 part of ethynylhexanol was added. To 100 parts of the mixture obtained, which contained 60 wt % of siloxane components, 50 parts of toluene, and 0.5 part of a platinum catalyst, CAT-PL-50T, ex Shin-Etsu Chemical Co. Ltd, were added, and thereby a solution of a pressure sensitive adhesive silicone composition containing about 40% of siloxanes components was obtained.

Each silicone composition was evaluated according to the method described above. Results are as shown in Table 1, wherein “R.Ex.” stands for Referential Example and “C.Ex.” stands for Comparative Example.

TABLE 1

| | Alkenyl | Molar ratio, | Adhesion | Adhesive residue | | | | Stain | | | |
|---|---|---|---|---|---|---|---|---|---|---|---|
| | content | [MeHSiO/Me₂SiO], of | strength | aging time at 280° C. | | | | aging time at 280° C. | | | |
| | (mol/100 g) | organosiloxane(C) | (N/25 mm) | 10 min | 30 min | 1 h | 4 h | 10 min | 30 min | 1 h | 4 h |
| Ex. 1 | 0.007 | 73/27 | 2.5 | A | A | A | B | A | A | A | A |
| Ex. 2 | 0.02 | 73/27 | 0.98 | A | A | A | A | A | A | A | A |
| Ex. 3 | 0.04 | 73/27 | 0.05 | A | A | A | A | A | A | A | A |
| Ex. 4 | 0.007 | 73/27 | 1.5 | A | A | A | A | A | A | A | A |
| Ex. 5 | 0.007 | 73/27 | 2.5 | A | A | A | A | A | A | A | A |
| Ex. 6 | 0.007 | 73/27 | 2.5 | A | A | A | A | A | A | A | A |
| R. Ex. 1 | 0.007 | 73/27 | 2.5 | A | A | A | B | A | B | B | B |
| R. Ex. 2 | 0.02 | 73/27 | 0.98 | A | A | A | A | A | B | B | B |
| R. Ex. 3 | 0.04 | 73/27 | 0.05 | A | A | A | A | A | B | B | B |
| R. Ex. 4 | 0.007 | 73/27 | 1.5 | A | A | A | A | A | A | B | B |
| R. Ex. 5 | 0.007 | 73/27 | 2.5 | A | A | A | A | A | A | B | B |
| R. Ex. 6 | 0.007 | 73/27 | 2.5 | A | A | A | A | A | A | B | B |
| C. Ex. 1 | 0.0014 | 73/27 | 5.6 | B | C | C | C | C | C | C | C |
| C. Ex. 2 | 0.0014 | 73/27 | 5.6 | B | C | C | C | C | C | C | C |
| C. Ex. 3 | 0.007 | 100/0 | 2.5 | A | B | B | B | B | C | C | C |
| C. Ex. 4 | 0.007 | 100/0 | 2.5 | A | B | B | B | B | C | C | C |
| C. Ex. 5 | 0.007 | 100/0 | 1.2 | A | A | B | C | B | B | C | C |
| C. Ex. 6 | 0.007 | 100/0 | 1.2 | A | A | B | C | B | B | C | C |

As shown in Table 1, the pressure sensitive adhesive tapes obtained from the silicone compositions of Examples were peeled off without leaving adhesive residues and stains on the metal plates even after aged at a high temperature of 280° C. The present pressure sensitive adhesive tape is useful as a masking tape or temporary bonding tape in a reflow process run at a temperature of 250° C. or higher.

1. A silicone composition for use as a pressure sensitive adhesive, comprising
a mixture obtained by reacting (A) a polyorganosiloxane having at least two alkenyl groups per molecule with (B) a polyorganosiloxane having an R¹₃SiO_{0.5} unit and an SiO₂ unit, wherein R¹ may be the same with or different from each other and is a monovalent hydrocarbon group having 1 to 10 carbon atoms,
(C) a polyorganosiloxane having an SiH group,
(D) a retarder and
(E) a platinum group metal catalyst,
said composition leaving no residue originating from the composition on a surface of stainless steel when tested according to the following method:
(1) applying the composition on a substrate, followed by heating at a temperature of from 110 to 140° C. for 1 to 3 minutes to prepare a pressure sensitive adhesive tape,
(2) pressure bonding the applied composition of the pressure sensitive adhesive tape to the surface of stainless steel, followed by heating at a maximum temperature of from 250 to 300° C. for at least 10 minutes, and
(3) manually peeling off the pressure sensitive adhesive tape from stainless steel after cooled to room temperature and observing with the naked eye the surface of stainless steel.

2. The composition according to claim 1, wherein the reaction is carried out in the presence of a basic catalyst in an organic solvent at a temperature of from 80 to 150° C. for 2 to 24 hours.

3. The silicone composition according to claim 1, wherein, when the pressure sensitive adhesive tape is applied on a 25 mm wide polyimide tape in the step (1), said pressure sensitive adhesive tape shows a 180-degree peel strength of from 0.05 to 4 N/25 mm, as measured at a pulling rate of 300 mm/min at a temperature of 25° C., after allowed to stand at room temperature for 18 to 22 hours.

4. The silicone composition according to claim 1, wherein the composition comprises
a mixture obtained by reacting 20 to 95 parts by weight of (A) the polyorganosiloxane having an alkenyl content of from 0.0015 to 0.06 mole/100 g with 80 to 5 parts by weight of (B) the polyorganosiloxane having a molar ratio of the R¹₃SiO_{0.5} unit to the SiO₂ unit of from 0.6 to 1.7,
(C) the polyorganosiloxane having at least three SiH groups per molecule in such an amount that a molar ratio of the SiH groups to the alkenyl group of the polyorganosiloxane (A) ranges from 0.5 to 20, 0 to 8.0 parts by weight, based on a total 100 parts by weight of (A) and (B) before reacted, of the retarder (D) and
1 to 5,000 ppm calculated as platinum, based on a total 100 parts by weight of (A) and (B) before reacted, of the platinum group metal catalyst (E).

5. The silicone composition according to claim 4, wherein the polyorganosiloxane (A) has an alkenyl content of from 0.002 to 0.04 mole/100 g.

6. The silicone composition according to claim 4, wherein the polyorganosiloxane (c) is contained in such an amount that the molar ratio of the SiH groups to the alkenyl group of the polyorganosiloxane (A) ranges from 3 to 15.

7. The silicone composition according to claim 4, wherein the polyorganosiloxane (C) comprises at least one polyorganosiloxane selected from the polyorganosiloxanes represented by the following formulae: 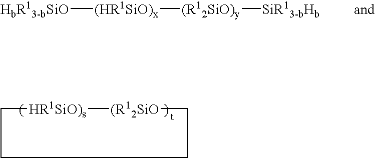
wherein R¹ may be the same with or different from each other and is a monovalent hydrocarbon group having no aliphatic unsaturated group; b is 0 or 1; x is an integer of 1 or larger, provided that x is 3 or larger when b is zero, and y is an integer of 1 or larger, s is an integer of 2 or larger, and t is an integer of 1 or larger.

8. The silicone composition according to claim 1, wherein the composition further comprises 0.01 to 1 part by weight of (F) a hindered amine compound, based on a total 100 parts by weight of (A) and (B) before reacted, and/or 0.1 to 10 parts by weight of (G) a phenolic antioxidant, based on a total 100 parts by weight of (A) and (B) before reacted.

9. A pressure sensitive adhesive tape comprising a substrate and a pressure sensitive adhesive layer provided on the substrate, wherein the pressure sensitive adhesive layer comprises the silicone composition according to any one of claims 1 to 8.
